(19) United States
(12) Patent Application Publication
(10) Pub. No.: US 2010/0126072 A1
(43) Pub. Date: May 27, 2010

(54) Door Operating Device of Air Conditioner for Automobile

(75) Inventors: Eung Young Kim, Anyang-si (KR); Kwang Ok Han, Seoul (KR)

Correspondence Address: MORGAN, LEWIS & BOCKIUS LLP (SF), One Market, Spear Street Tower, Suite 2800, San Francisco, CA, 94105, US

(73) Assignee: Hyundai Motor Company, Seoul (KR)

(21) Appl. No.: 12/370,375

(22) Filed: Feb. 12, 2009

(30) Foreign Application Priority Data
Nov. 24, 2008 (KR) 10-2008-0116798

(51) Int. Cl. G05G 9/00; B60H 1/24

(52) U.S. Cl. 49/94; 74/471 R

(57) ABSTRACT

A door operating device of an air conditioner for an automobile may include a cam plate which is rotatably connected to a stationary member to rotate according to a conversion of an air conditioning mode, and a plurality of rotation lever, one end of which is coupled to respective mode door and the other one end of which is connected to a guide member formed to the cam plate to guide movement of the other end of the rotation lever in response to rotation of the cam plate, the mode doors being pivotally coupled to the stationary member, wherein opening amounts of respective mode door are regulated according to a rotation angle of the cam plate which rotates by a control member to convert the air conditioning mode.

### CROSS-REFERENCE TO RELATED APPLICATION

The present application claims priority to Korean Patent Application Number 10-2008-0116798 filed Nov. 24, 2008, the entire contents of which application is incorporated herein for all purposes by this reference.

### BACKGROUND OF THE INVENTION

1. Field of the Invention

The present invention relates to a door operating device of an air conditioner for an automobile, and more particularly, to a door operating device of an air conditioner for an automobile in which a defrost door, a vent door, and a floor door can be controlled in a cooperative manner.

2. Description of Related Art

Generally, a door operating device of an air conditioner for an automobile is provided with an air conditioning case in which an air blower is connected to an entrance thereof, and an evaporator and a heater core which are disposed within the air conditioning case.

The evaporator is connected to systems for a cooling cycle, and the heater core is connected to systems for a heating cycle.

That is, in case that the cooling cycle operates, air blown by the air blower undergoes heat exchange while passing the evaporator to be changed into cooled air, and is then discharged into a cabin of an automobile, so a cabin is cooled.

Further, in case that the heating cycle operates, the operation of the cooling cycle is stopped, and air blown by the air blower undergoes heat exchange while passing the heater core to be changed into heated air, and is then discharged into a cabin of an automobile, so a cabin is heated.

In addition, in order to control amount of air, temperature, direction of discharged air in a cabin, and so on, a plurality of doors such as an air intake door for selectively determining suction of inner/outer air, a temperature control door controlling amount of air passing the heater core and amount of bypass air, mode doors for determining a vent mode, a defrost mode, a floor mode, a mix mode, a bi-level mode, and so on, etc., are provided, and the mode doors control the amount of opening of an air discharge outlet thereby converting the modes.

The doors can be manually operated, and if the corresponding switch is manipulated in a cabin, the doors are operated by cables connected to the switch, rotation lever mechanisms connecting the cable and the door, and so on.

Furthermore, in a premium car provided with an automatic temperature control device, a door actuator which is operated by an output signal of a controller is provided at an outer surface of an air conditioning case, and is connected to a shaft of a door directly or via a rotation lever mechanism, so the doors can be automatically feedback-controlled.

However, the air conditioner using the door actuator has an actuator for the respective doors, and this causes increase of manufacturing cost. Furthermore, since separate structures such as a wiring harness and a connecting member which are auxiliary connected for controlling the door actuator are needed, assembling processes and the number of assembling parts are increased, so there is a problem in that productivity is deteriorated and manufacturing cost is increased.

### BRIEF SUMMARY OF THE INVENTION

Various aspects of the present invention provide for a door operating device of an air conditioner for an automobile in which a vent door, a defrost door, and a floor door can be controlled simultaneously using a single cam, so respective air discharge outlets of an air conditioning case can be selectively opened and closed by a single actuator provided at an center of the cam, and therefore a door operating device which can realizes various air conditioning modes can be simplified.

One aspect of the present invention is directed to a door operating device of an air conditioner for an automobile, including a cam plate which is rotatably connected to a stationary member to rotate according to a conversion of an air conditioning mode, and/or a plurality of rotation lever, one end of which is coupled to respective mode door and the other one end of which is connected to a guide member formed to the cam plate to guide movement of the other end of the rotation lever in response to rotation of the cam plate, the mode doors being pivotally coupled to the stationary member, wherein opening amounts of respective mode door are regulated according to a rotation angle of the cam plate which rotates by a control member to convert the air conditioning mode.

The stationary member may be an air conditioner case, wherein the rotation lever is disposed between the cam plate and the air conditioner case and wherein the cam plate and the rotation lever are disposed at an outer wall of the air conditioner case.

The rotation levers may be disposed between the cam plate and the stationary member.

The guide member may be a slot and the other end of the rotation lever is slidably coupled to the slot, wherein respective slot is not connected each other.

The other end of respective rotation lever may be disposed with a predetermined angle therebetween with respect to a rotational axis of the cam plate.

One of the mode doors may be a floor door configured to flow air into a cabin of the automobile, wherein the floor door is configured to be spaced from the cam plate with a predetermined distance, further including an auxiliary lever connected to the floor door to be pivotally connected to one of the rotation levers.

One of the rotation levers may include a vent door configured to flow air outside a cabin of the automobile.

One of the rotation lever may include a defrost door configured to flow air onto a window of the automobile.

A control member may be coupled to a rotational axis of the cam plate and configured to control the rotation angle of the cam plate.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a perspective view of an exemplary door operating device of an air conditioner for an automobile according to the present invention.

FIG. 2 is an exploded perspective view of an exemplary door operating device of an air conditioner for an automobile according to the present invention.

FIG. 3 to FIG. 9 are schematic drawings showing exemplary operating states of a door operating device of an air conditioner for an automobile according to the present invention.

### DETAILED DESCRIPTION OF THE INVENTION

Reference will now be made in detail to various embodiments of the present invention, examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

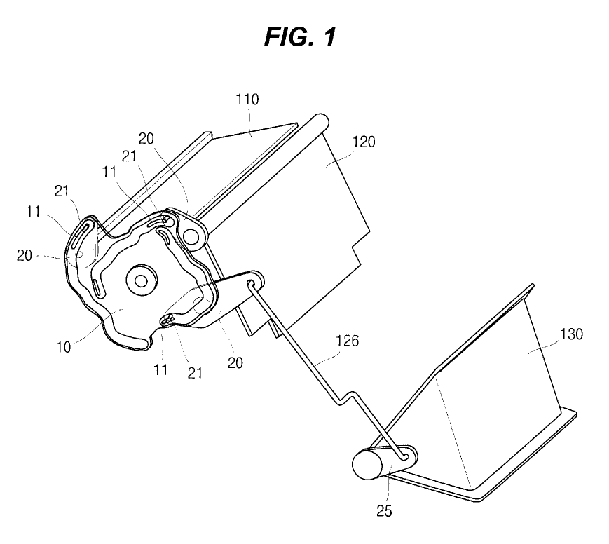

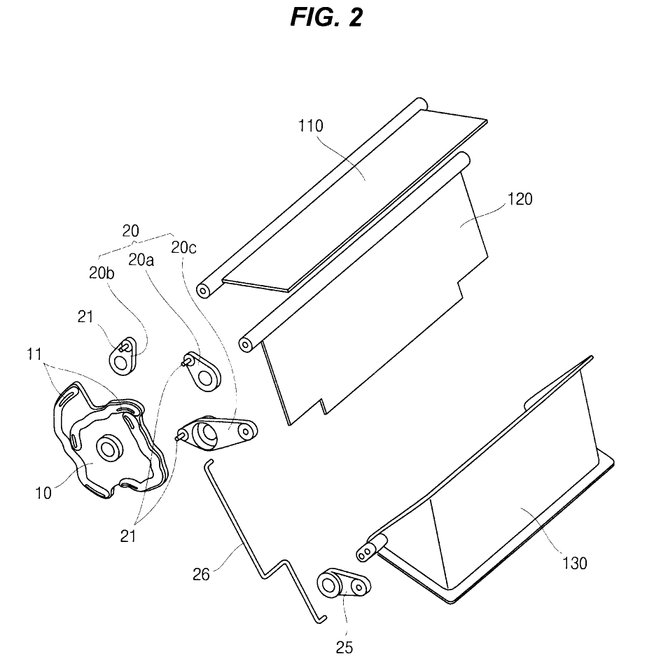

As shown in FIG. 1 and FIG. 2, a door operating device of an air conditioner for an automobile includes a cam plate 10 which is rotatably connected to an outer wall of an air conditioner case 100 to rotate according to a conversion of an air conditioning mode, and a plurality of rotation levers 20 which are provided the outer wall of the air conditioner case 100 to be able to rotate in response to the rotation of the cam plate 10, and the cam plate 10 and the rotation lever 20 are connected to one another by a connecting means composed of guide slots 11, 12 and 13 formed along the outer circumference of the cam plate 10 and a protrusion 21 formed to be protruded at an end of the rotation lever 20, and opening amounts of respective mode doors 110, 120, and 130 which are composed of vent, defrost, floor, etc., are regulated according to a rotation angle of the cam plate 10.

The cam plate 10 can rotate by rotation of an actuator which is shaft-connected to a rotational axis of the cam plate 10 by manipulation of a mode switch provided to an instrument panel of a cabin of an automobile.

Furthermore, the rotation lever 20 is disposed between the cam plate 10 and the air conditioner case 100, that is, to be closer to an outer wall of the air conditioner case 100 than the cam plate 10, and controls an amount of opening of mode doors 110, 120, and 130 while operating together with the cam plate 10.

At this time, for example, a lever indicated by the reference numeral 20a among the rotation levers 20 is a first rotation lever for operating a vent door 120, a lever indicated by the reference numeral 20b is a second rotation lever for operating a defrost door 110, and a lever indicated by the reference numeral 20c is a third rotation lever for operating a floor door 130. The first rotation lever 20a includes a protrusion 21 to be slidably coupled to the first guide slot 11. The second rotation lever 20b includes a protrusion 21 to be slidably coupled to the second guide slot 12.

Meanwhile, among the mode doors 110, 120, and 130, the floor door 130 is provided at a lower end portion of the air conditioner case 100 to be apart from the cam plate 10 by a predetermined distance, so is not directly connected to the third rotation lever 20c.

The third rotation lever 20c including a hinge 23 is pivotally coupled to a stationary member such as the air conditioner case 100, for instance by a rotating shaft so as to rotatably support the third rotation lever 20c. One end of third rotation lever 20c includes a protrusion 21 to be slidably coupled to the third guide slot 13.

Accordingly, the third rotation lever 20c directly connected to the cam plate 10 are connected to the floor door 130 by a cable 26 and an auxiliary lever 25 connected to the floor door 130, so amount of opening of the floor door 130 is controlled by rotation of the cam plate 10 and the third rotation lever 20c and by movement of the cable 26.

Operations of a door operating device of an air conditioner for an automobile according to various embodiments of the present invention will be explained hereinafter.

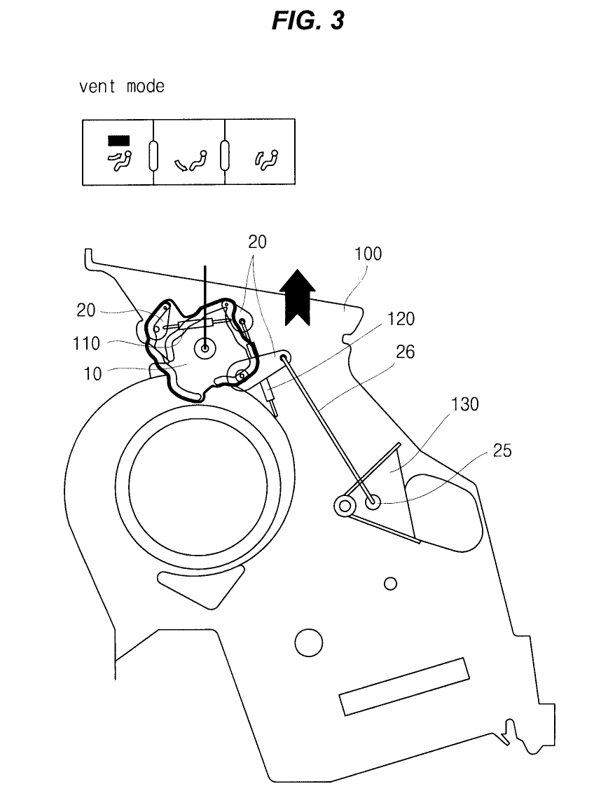

FIG. 3 to FIG. 9 are drawings showing operating states of a door operating device of an air conditioner for an automobile according to various embodiments of the present invention.

First, in case of operating a mode switch to convert air discharge mode for a cabin of an automobile by operating doors, an actuator operates so that the cam plate 10 which is disposed at an outer wall of the air conditioner case 100 operates to rotate.

The rotation lever 20 which rotates by the rotation of the cam plate 10 controls the amount of opening of the mode doors 110, 120, and 130 which are connected thereto, and as shown in FIG. 3, the vent mode in the mode switch indicates the state in which the cam plate 10 does not rotate just like the initial state of an air conditioning system.

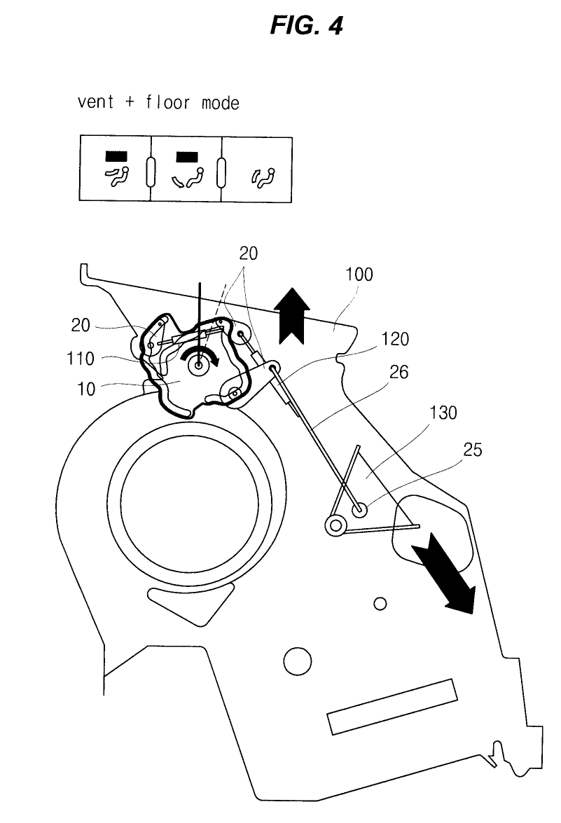

As shown in FIG. 4, in case of operating the vent mode and the floor mode at the same time in the mode switch, the cam plate 10 rotates in a clockwise by a predetermined angle so as to open the vent door 120 and the floor door 130 by a predetermined amount to allow air to be discharged into a cabin of an automobile.

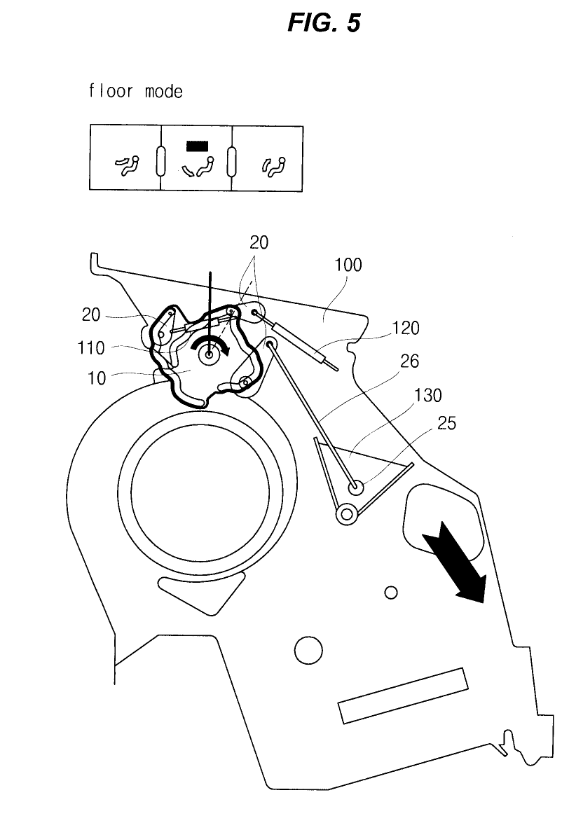

In addition, as shown in FIG. 5, in case of operating the floor mode, the cam plate 10 rotates further in a clockwise by a predetermined angle than the mode of FIG. 4 so as to cut off the vent door 120 and open only the floor door 130 to allow air to be discharged into a cabin of an automobile.

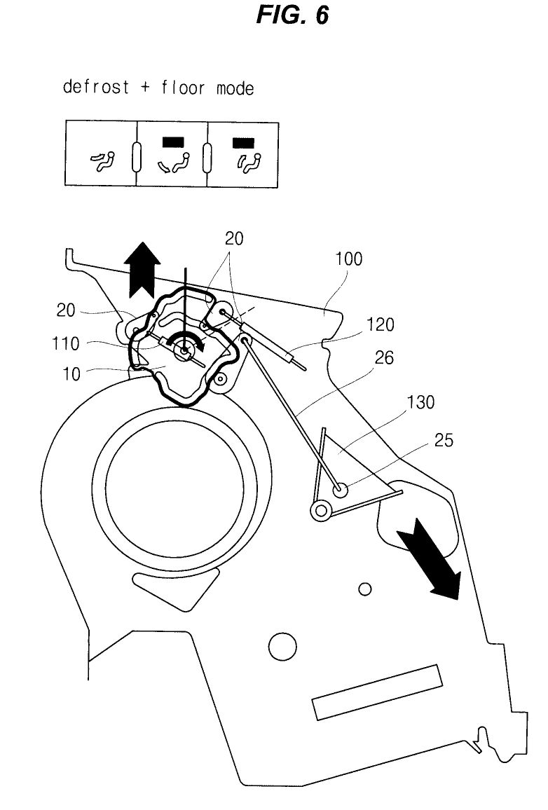

As shown in FIG. 6, in case of operating the defrost mode and the floor mode at the same time, the cam plate 10 rotates further in a clockwise by a predetermined angle than the mode of FIG. 5 so as to remain the floor door in an open state and open the defrost door 110.

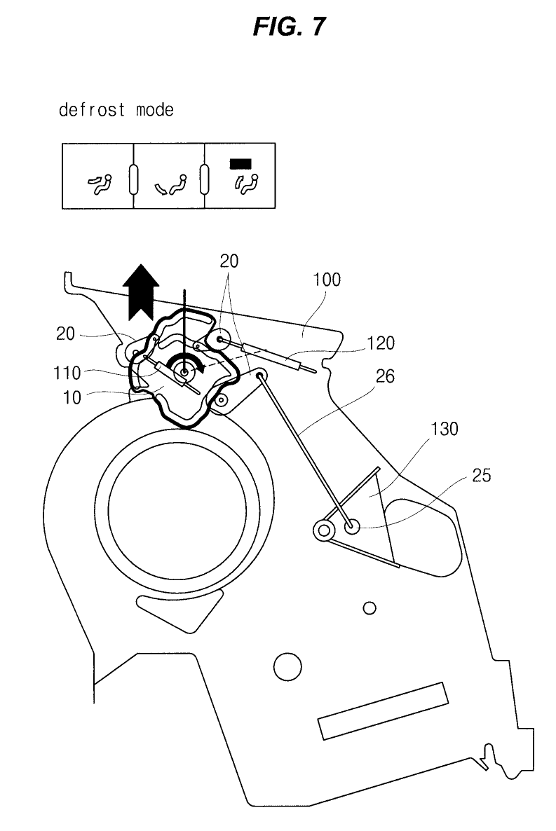

As shown in FIG. 7, in case of operating only the defrost mode, the cam plate 10 rotates further in a clockwise by a predetermined angle than the mode of FIG. 6 so as to remain the defrost door 110 in an open state and cut off only the floor door 130.

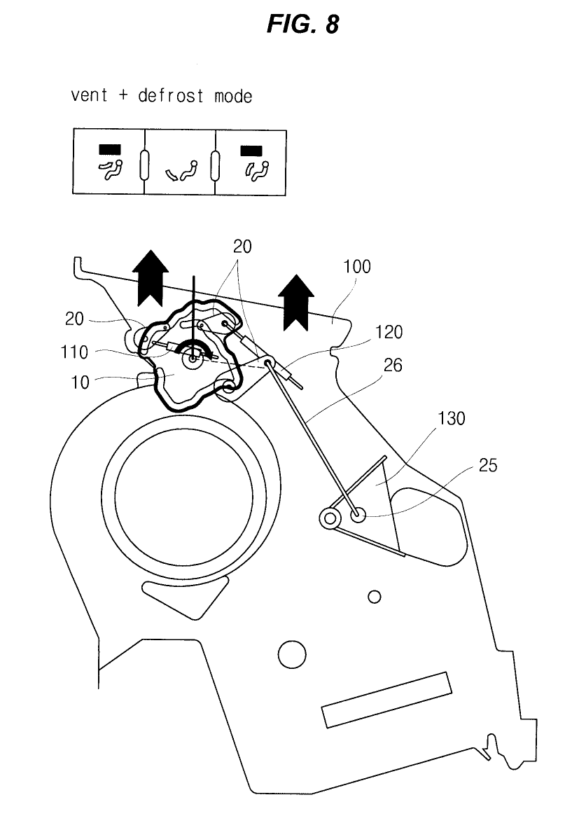

As shown in FIG. 8, in case of operating the vent mode and the defrost mode at the same time, the cam plate 10 rotates further in a clockwise by a predetermined angle than the mode of FIG. 7 so as to remain the defrost door 110 in an open state and open the vent door 120.

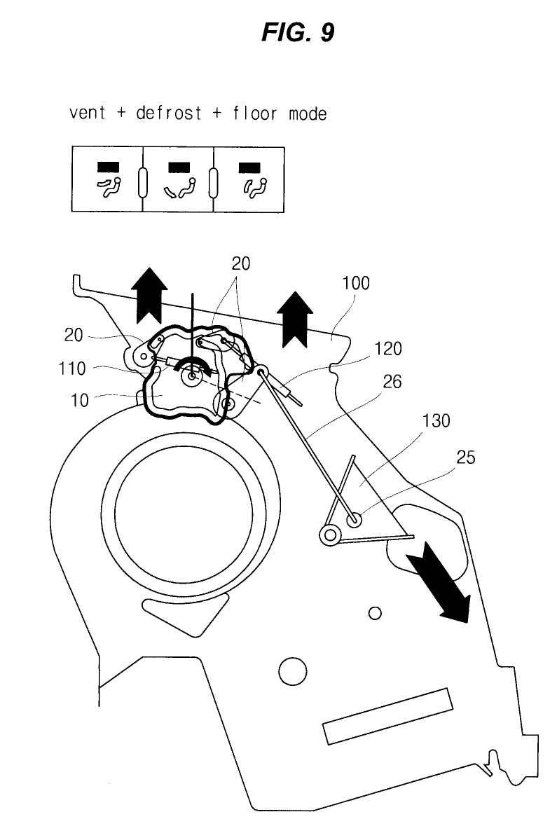

Furthermore, as shown in FIG. 9, in case of operating the vent mode, the defrost mode, and the floor mode at the same time, the cam plate 10 rotates further in a clockwise by a predetermined angle than the mode of FIG. 8 so as to remain the vent door 120 and the defrost door 110 in an open state and open the floor door 130 to allow air to be discharged into a cabin of an automobile.

That is, when the cam plate 110 rotates by the mode switch via an actuator, amount of opening of the respective mode doors 110, 120, and 130 is altered at predetermined angles so that air discharge outlets are selectively opened thereby realizing seven air conditioning modes.

As described above, according to a door operating device of an air conditioner for an automobile according to the present invention, marketable characteristics of an automobile can be enhanced in regard of characteristics of the European market preferring to a whole-mode discharge type.

When compared with a conventional air conditioning device using three actuators, a door operating device of an air conditioner for an automobile according to the present invention can realize a system having the same functions even in eliminating two actuators, so manufacturing cost can be reduced.

Furthermore, although a layout of a wiring harness for controlling an actuator should be considered, since two wiring harnesses are eliminated, the structure can be simplified and assembling and repairing can be eased.

For convenience in explanation and accurate definition in the appended claims, the terms “outer” and “inner” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A door operating device of an air conditioner for an automobile, comprising:
a cam plate which is rotatably connected to a stationary member to rotate according to a conversion of an air conditioning mode; and
a rotation lever, one end of which is coupled to respective mode door and the other one end of which is connected to a guide member formed to the cam plate to guide movement of the other end of the rotation lever in response to rotation of the cam plate, the mode doors being pivotally coupled to the stationary member;
wherein opening amounts of respective mode door are regulated according to a rotation angle of the cam plate which rotates by a control member to convert the air conditioning mode.

2. The door operating device of claim 1, wherein the stationary member is an air conditioner case.

3. The door operating device of claim 2, wherein the rotation lever is disposed between the cam plate and the air conditioner case.

4. The door operating device of claim 2, wherein the cam plate and the rotation lever are disposed at an outer wall of the air conditioner case.

5. The door operating device of claim 1, wherein the rotation lever is disposed between the cam plate and the stationary member.

6. The door operating device of claim 1, wherein the guide member is a slot and the other end of the rotation lever is slidably received within the slot.

7. The door operating device of claim 6, the door operating device comprising a plurality of rotation levers and guide members, wherein each rotation lever is received within a respective slot, and wherein respective slots are not connected each other.

8. The door operating device of claim 1, wherein the other end of respective rotation lever is disposed with a predetermined angle therebetween with respect to a rotational axis of the cam plate.

9. The door operating device of claim 1, wherein one of the mode doors is a floor door configured to flow air into a cabin of the automobile.

10. The door operating device of claim 9, wherein the floor door is configured to be spaced from the cam plate at a predetermined distance.

11. The door operating device of claim 9, further comprising an auxiliary lever connected to the floor door to be pivotally connected to the rotation lever.

12. The door operating device of claim 1, wherein the rotation lever includes a vent door configured to flow air outside a cabin of the automobile.

13. The door operating device of claim 1, wherein the rotation lever includes a defrost door configured to flow air onto a window of the automobile.

14. The door operating device of claim 1, wherein a control member is coupled to a rotational axis of the cam plate and configured to control the rotation angle of the cam plate.

15. A passenger vehicle comprising the door operating device of claim 1.
